(19) United States
(12) Patent Application Publication
(10) Pub. No.: US 2012/0005185 A1
(43) Pub. Date: Jan. 5, 2012

(54) SYSTEM AND METHOD FOR LOCATING DATA FEEDS

(75) Inventors: Satish Gudiboina, Arlington, VA (US); Kirill Ulyanov, San Ramon, CA (US)

(73) Assignee: CBS INTERACTIVE INC., San Francisco, CA (US)

(21) Appl. No.: 13/075,967

(22) Filed: Mar. 30, 2011

Related U.S. Application Data
(60) Provisional application No. 61/360,433, filed on Jun. 30, 2010.

(51) Int. Cl. G06F 17/30

(52) U.S. Cl. 707/706; 707/E17.108

(57) ABSTRACT

Systems and methods for locating data feeds are disclosed that allow a user to receive a list of all available content from RSS feeds on a website are described. Users request a list of content by typing terms corresponding to the desired results into a designated URL address. The system determines what results to provide to the user based on a hierarchy of RSS items comprising pre-determined nodes, assets, categories, and keywords. Matching results are mashed up, an RSS feed template is applied to the results, and the list is presented to the user.

### RELATED APPLICATION

This application claims the benefit of U.S. Provisional Application No. 61/360,433, filed Jun. 30, 2010, the disclosure of which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention relates to a system and method for locating data feeds.

2. Description of Related Art

The World Wide Web has become a primary source of communication amongst millions of individuals in recent years. Web pages are accessed by individuals for various purposes such as entertainment, education, information exchange, and online shopping. As a result, more and more businesses have turned to the internet to market and advertise to potential customers, to disseminate information about their brands to the public, and to accept orders for their products and services.

RSS, generally defined as “Really Simple Syndication” or “Rich Site Summary”, is a mechanism that produces data feeds in a standard format that can be easily rendered by a browser or a dedicated reader application. RSS permits websites to easily share updates with users feeds usually include the full or summarized text of the updated content, as well as metadata describing the author, date and time of publication, etc. RSS feeds are typically used for content that is frequently updated, such as blogs, news, digital media, products, reviews, and the like.

RSS feeds can be produced by a website developer in a number of ways. First, website development software that is used to add content to a website can also be used to update an RSS feed at the same time. Second, software made specifically to produce RSS feed files can be used to track website updates and publish a feed automatically. Finally, website developers can create and maintain an RSS feed by hand, using a standardized XML file format.

RSS feeds provide numerous benefits to both content publishers and content consumers, such as, for example, users. Publishers are able to syndicate content automatically, while users are able to stay informed with timely updates from their favorite websites. Furthermore, users are able to aggregate many feeds from multiple websites into a single RSS document. This saves the user from visiting each website individually, while ensuring privacy by not requiring a newsletter or other website-specific subscription.

However, current RSS feeds also have many disadvantages. For instance, the number of content updates published on a subscriber's feed can become numerous and unmanageable. The feed may also include multiple updates of content that a subscriber is not interested in. Furthermore, current RSS feeds are often difficult to personalize and customize to a subscriber's satisfaction.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 is a flowchart illustrating the method according to one embodiment.

FIG. 2 is a system for effecting the method according to another embodiment.

FIG. 3 is a block diagram of another system architecture for implementing the method according to one embodiment.

FIG. 4 is a schematic diagram of an exemplary computer system according to one embodiment.

FIG. 5 is a screenshot of a customized RSS feed created using the method according to one embodiment.

### DETAILED DESCRIPTION

Thus, there is a need in the art for systems and methods for locating content from feeds that can be easily accessed, sorted, and personalized, without extreme difficulty and skill by the user. The embodiments described herein meets those needs and others by providing systems and methods that allow a user to receive a list of content from feeds on a website by simply querying an area of interest.

In one embodiment, the system determines what list results to provide to the user based on a hierarchy of RSS item nodes predetermined by the system. The system first looks to pre-defined nodes that the user may enter, such as “recent”, “popular”, “budget”, and so on. If the user types in any of these pre-defined nodes, it will automatically provide a predetermined list of results (with associated RSS feeds) for that particular pre-defined node.

If the user's entry does not match a pre-defined node, the system then looks for asset nodes, such as “product”, “software”, “news”, “blogs”, “discussions”, and the like, which are automatically mapped to various predetermined assets. If the user's entry does not match any of the above, the system attempts to match the entry to a category name, in which a category filter on the results is used. If the entry still does not match a category name, a keyword search is performed, and matching results are presented to the user

In one embodiment, the method includes receiving a query at a computing device, wherein the query includes at least one domain operator and at least one user-entered term associated with desired results, retrieving from the domain specified by the domain operator one or more links to content from data feeds relating to the user-entered term, and transmitting the links to the user as a web page. The system is a computing device programmed with instructions to accomplish these functional steps.

Still other aspects, features and advantages of the present invention are readily apparent from the following detailed description, simply by illustrating a number of exemplary embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

A system and method for generating customized RSS feeds is described. In the following description, for purposes of explanation, numerous specific details are set forth in order to provide a thorough understanding of the exemplary embodiments. It is apparent to one skilled in the art, however, that the present invention can be practiced, as defined by the appended claims, is not limited by these specific details. In some instances, well-known structures and devices are shown in block diagram form in order to avoid unnecessarily obscuring the disclosed embodiment.

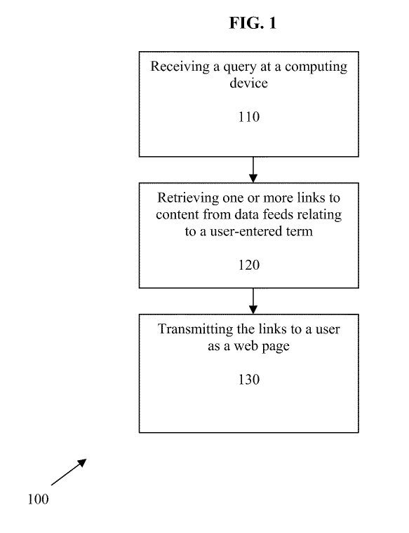

Referring now to the drawings, wherein like reference numerals designate identical or corresponding parts throughout the several views, FIG. 1 is a flowchart 100 illustrating the method according to one embodiment. At processing block 110, a query is received at a computing device. The query includes at least one domain operator and at least one user-entered term associated with desired results. In one embodiment, the domain operator is a URL, such as, for example, http://www.cnet.com/rss/recent, that generates an API search request. A query can also contain multiple domain operators and/or multiple user-entered terms, causing multiple API search requests to be generated.

At processing block 120, one or more links to content from data feeds relating to the user-entered term is retrieved from the domain specified by the domain operator. In one embodiment, the data feeds are RSS feeds, or “Really Simple Syndication” feeds, that produce lists of recently updated content. In the above example, the links are retrieved from the domain cnet.com. However, if more than one domain operator is received, the links can be retrieved from multiple domains. In the event that the domain operators for a query specify multiple domains, links from each domain will be located according to the methods described above. Once the links from each domain are retrieved, they can be “mashed up” into a single data feed of links, and the redundancies will be removed.

The user-entered term retrieved from the domain can be, for example, a pre-defined node, an asset, a category, a keyword, or any combination thereof. A pre-defined node can correspond semantically to any word that is pre-mapped to specific search, such as, for example, “recent”, “popular”, “budget”, etc. In the above example, the URL http://www.cnet.com/rss/recent, would perform a pre-programmed search to retrieve links to the most recent data feeds.

An asset corresponds to a pre-defined collection of content available from the domain. Exemplary assets include “product”, “software”, “news”, “blogs”, “discussions”, etc. A category is a pre-defined subset of an asset. For example, the “product” asset may have categories such as “computers”, “games”, “MP3+players”, “laptops”, “cell+phones”, “printers”, “cameras”, “televisions”, “DVD+players”, etc. A keyword is any user-entered term that has not been pre-defined as a node, asset, or category. Instead of performing a pre-programmed search, receipt of a user-entered keyword results in a simple word search of the domain for data lists, RSS feeds, content, web pages, etc., that contain the user-entered keyword. In any case, after the links relevant to the user-entered term(s) are retrieved, an RSS template is applied to the results, and they are transmitted to the requesting user as a web page at processing block 130.

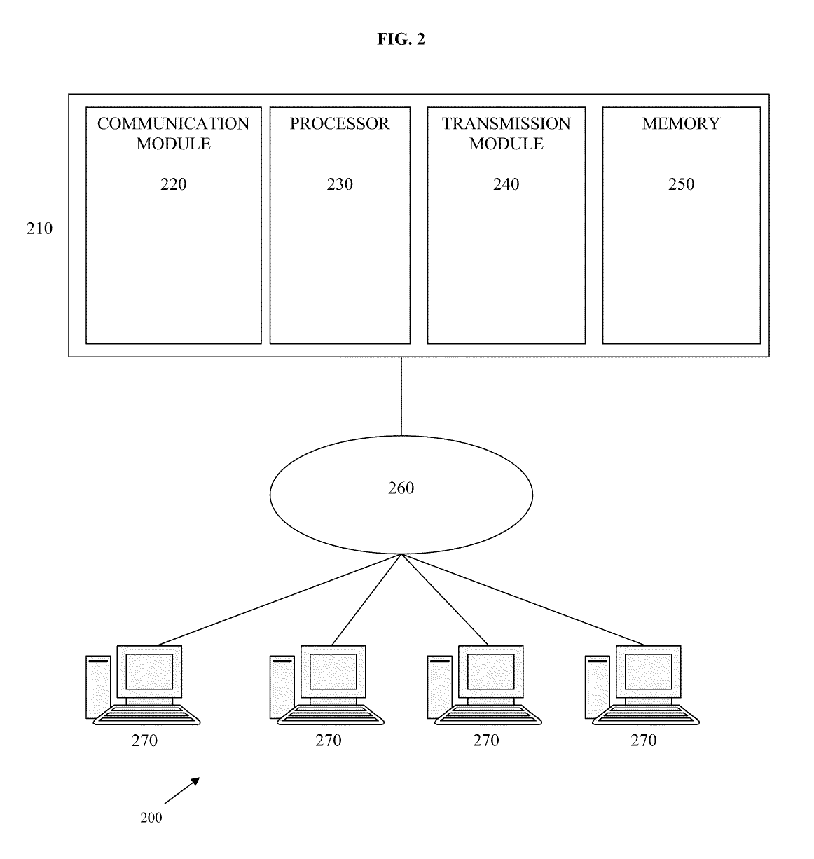

FIG. 2 illustrates system 200 of an embodiment for effecting the functions described above. Server 210 is connected over network 260 to a plurality of user systems 270. Server 210 includes communication module 220, processor 230, transmission module 240, and memory 250, which are all in communication with one another. Server 210 is configured to locate and transmit data feeds to users at the plurality of user systems 270. Server 210 is typically a computer system, and may be an HTTP (Hypertext Transfer Protocol) server, such as an Apache server. Server 210 may be built using a standard LAMP or other solution stack. Memory 250 may be any type of storage media that may be volatile or non-volatile memory that includes, for example, read-only memory (ROM), random access memory (RAM), magnetic disk storage media, optical storage media, flash memory devices, and zip drives. Network 260 may be a local area network (LAN), wide area network (WAN), a telephone network, such as the Public Switched Telephone Network (PSTN), an intranet, the Internet, or combinations thereof. The plurality of user systems 270 may be mainframes, minicomputers, personal computers, laptops, personal digital assistants (PDAs), cell phones, netbooks, thin clients, tablets, and other computing devices. The plurality of user systems 270 are characterized in that they are capable of being connected to network 260. The plurality of user systems 270 typically include web browsers.

In use, when a user of one of the plurality of user systems 270 wants to, for example, locate data feeds as described above, a query is communicated to communication module 220 of server 210 over network 260. For example, a request is transmitted from one of the user systems 270, the request having a destination address (i.e., address representing the server), a query (i.e., one or more domain operators and one or more user-entered terms), and a return address (i.e., address representing the user system that initiated the request. Processor 230 accesses memory 250 and/or network 260 to retrieve links to content from data feeds relating to the user-entered term(s) from the domain(s) specified by the domain operator(s) in the user's query using one or more API requests. Processor 230 also refines and mashes up the links, if necessary. Transmission module 240 transmits the links to the user over network 260. For example, a response may be transmitted that includes a destination address corresponding to the return address of the client system and the links to feeds responsive to the query. The functions of this and other embodiments can be effected by modules of computer executable instructions recorded on tangible media. The modules can be segregated in various manners over various devices.

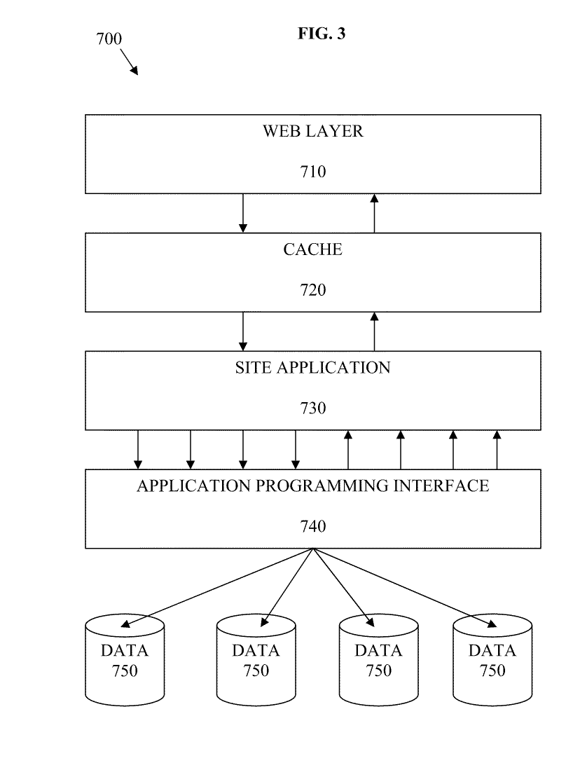

As shown in another embodiment FIG. 3, system architecture 700 includes web layer 710, cache 720, site application 730, application programming interface 740, and a plurality of data stores 750. It will be appreciated that the system architecture may vary from the illustrated architecture. For example, web layer 710 may directly access data stores 750, the site application may directly access data stores 750, system architecture 700 may not include cache 720, etc., as will be appreciated by those skilled in the art. Web layer 710 is configured to receive user queries including domain operator(s) and user-entered term(s) associated with desired results through a web browser, and return links and/or web pages responsive to the user query. Web layer 710 communicates the user queries to cache 720. Cache 720 is configured to temporarily store links and/or web pages that are accessed frequently by web layer 710 and can be rapidly accessed by web layer 710. In one embodiment, cache 720 may be a caching proxy server. Cache 720 communicates the user queries to site application 730.

Site application 730 is configured to update cache 720 and to process user queries received from web layer 719. Site application 730 may identify that the domain operator(s) of the user's query indicate domains and/or user-entered terms that correspond to data from multiple sources. Site application 730 can then convert the query into a request for links from multiple sources and transmit these requests to application programming interface 740. Application programming interface 740 is configured to either (a) simultaneously or (b) consecutively, according to the hierarchy described above, access data from the plurality of data stores 750 to collect the data responsive to the plurality of requests from site application 730. The plurality of data stores 750 may include, for example, links, RSS feeds, web pages, and the like. It will be appreciated that in alternative embodiments only one data store 750 may be provided to store the data.

The data in data stores 750 is provided to application programming interface 740, which provides the content to site application 730. Site application 730 updates cache 720 and delivers the cached content in combination with the accessed content to web layer 710, which delivers content to the user.

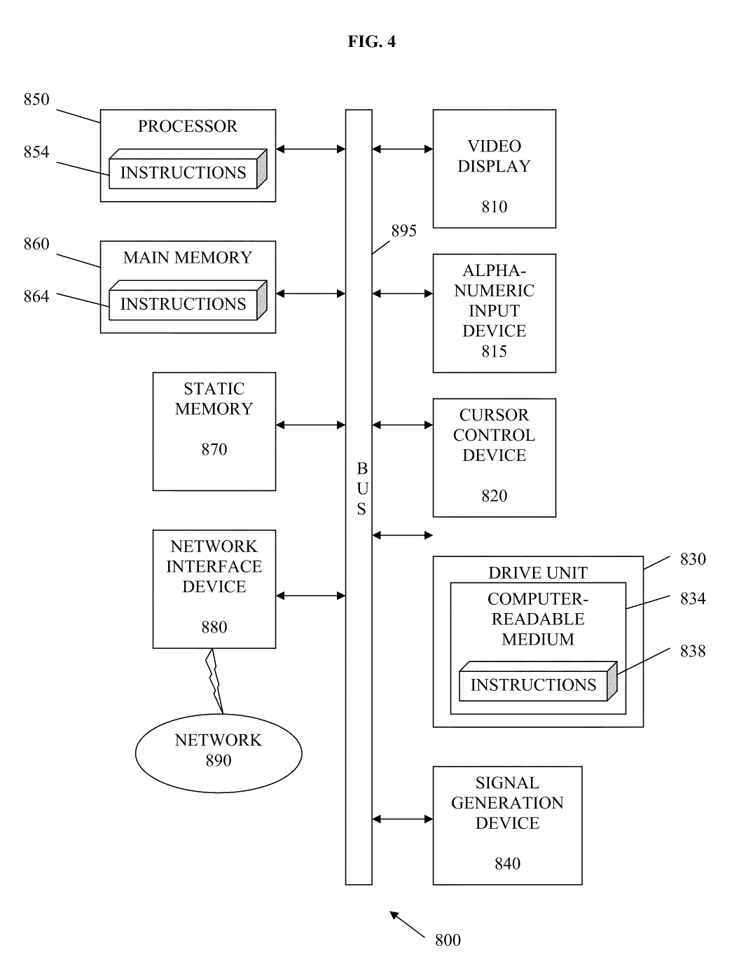

FIG. 4 shows a diagrammatic representation of a machine in the exemplary form of computer system 800 within which a set of instructions, for causing the machine to perform any of the one or more methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Computer system 800 includes processor 850 (e.g., a central processing unit (CPU), a graphics processing unit (GPU) or both), main memory 860 (e.g., read only memory (ROM), flash memory, dynamic random access memory (DRAM) such as synchronous DRAM (SDRAM) or Rambus DRAM (RDRAM), etc.) and static memory 870 (e.g., flash memory, static random access memory (SRAM), etc.), which communicate with each other via bus 595.

Computer system 800 may further include video display unit 810 (e.g., a liquid crystal display (LCD) or a cathode ray tube (CRT)). Computer system 800 also includes alphanumeric input device 815 (e.g., a keyboard), cursor control device 820 (e.g., a mouse), disk drive unit 830, signal generation device 840 (e.g., a speaker), and network interface device 880.

Disk drive unit 830 includes computer-readable medium 834 on which is stored one or more sets of instructions (e.g., software 838) embodying any one or more of the methodologies or functions described herein. Software 838 may also reside, completely or at least partially, within main memory 860 and/or within processor 850 during execution thereof by computer system 800, main memory 860 and processor 850 also constituting computer-readable media. Software 838 may further be transmitted or received over network 890 via network interface device 880.

While computer-readable medium 834 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

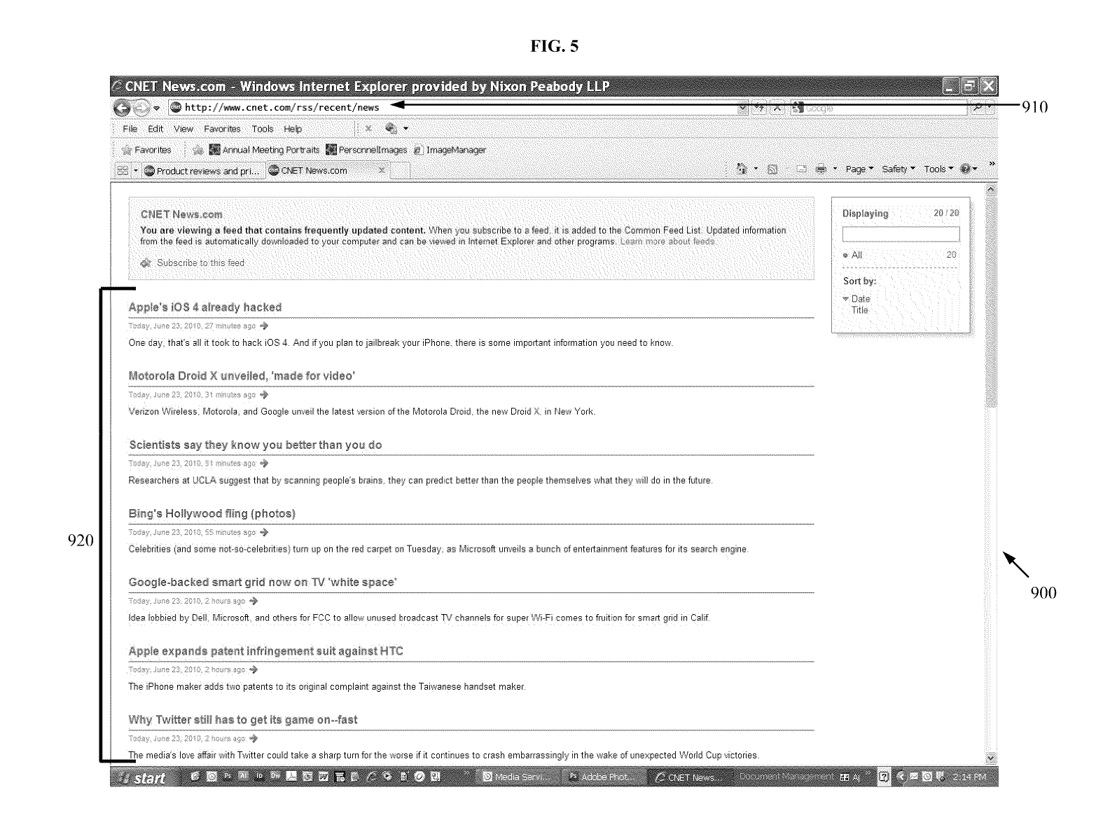

FIG. 5 shows exemplary screenshot 900 of a customized RSS feed created using the method as described above, according to one embodiment. As mentioned previously, multiple user-entered terms can be received in a single query. In this situation, links relating to the user-entered terms are retrieved according to a hierarchy wherein pre-defined nodes are searched first, assets second, categories third, and keywords last, regardless of the terms' positions in the query. In general, as the number of user-entered terms that are received in the query increases, the search becomes narrower and the number of relevant links decreases.

Query 910 of FIG. 5, specifying the URL “http://www.cnet.com/RSS/recent/news”, is received from a computing device. Query 910 has a domain operator, in this case, “www.cnet.com”, and user-entered terms “recent” and “news” associated with desired results.

Content 920 from RSS feeds relating to the terms “recent” and “news” are retrieved from the domain cnet.com, as specified by the domain operator. In this example, the term “recent” is a pre-defined node that may be searched first, followed by the asset “news”. In other words, the most recent content from RSS feeds may be retrieved from cnet.com first, from which only news content is extracted. Thus, the relevant data feeds 920 represent all recently added news content on cnet.com. An RSS template may be applied to data feeds 920 prior to transmittal to the requesting user as a web page, such as that shown in screen shot 900, so that the web page displayed itself represents an RSS.

In another example of multiple user-entered terms, the query http://www.cnet.com/rss/product/laptops/popular, will result in the pre-defined node “popular” being searched first, followed by the asset “product” and the category “laptops”. In other words, the most popular content from RSS feeds will be retrieved first, from which content from feeds about products will be extracted. From this list of the most popular products, content about laptops will be extracted. Thus, the resulting links will represent all popular laptop products on the domain.

In a further example, the query http://www.cnet.com/rss/news/blackberry+rim, will result in the asset “news” being searched first, followed by the keyword “rim+blackberry” (wherein the “+” symbol represents a user-entered representation of a space in the term to be searched). In other words, content from RSS feeds about news will be retrieved first, from which content from feeds containing or relating to the words “rim blackberry” will be extracted. Thus, the resulting links will represent all news related to the RIM Blackberry™ on the domain.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

Other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being defined by the following claims.

What is claimed is:

1. A method for locating data feeds, the method comprising:
receiving a query at a computing device, wherein the query includes at least one domain operator and at least one user-entered term associated with desired results;
retrieving from the domain specified by the domain operator one or more links to content from data feeds relating to the user-entered term; and
transmitting the links to a user.

2. The method of claim 1, wherein the domain operator is a URL.

3. The method of claim 1, wherein the query is an API search request.

4. The method of claim 1, wherein at least one of the data feeds is an RSS feed.

5. The method of claim 1, wherein the user-entered term is at least one of a pre-defined node, asset, category, and keyword.

6. The method of claim 5, wherein the pre-defined node is at least one of “recent”, “popular”, and “budget”.

7. The method of claim 5, wherein the asset is a collection of content available from the domain.

8. The method of claim 7, wherein the asset is at least one of “product”, “software”, “news”, “blogs”, and “discussions”.

9. The method of claim 5, wherein the category is a subset of the asset.

10. The method of claim 9, wherein the category is at least one of “computers”, “cameras”, “cell phones”, “games”, “printers”, “televisions”, and “MP3 players”.

11. A system for locating data feeds, the system comprising:
a communication module in a computing device, the communication module being configured to receive a query including at least one domain operator and at least one user-entered term associated with desired results;
a processor configured to retrieve from the domain specified by the domain operator one or more links to content from data feeds relating to the user-entered term; and
a transmission module in a computing device, the transmission module being configured to transmit the links to a user.

12. The system of claim 11, wherein the domain operator is a URL.

13. The system of claim 11, wherein the query is an API search request.

14. The system of claim 11, wherein at least one of the data feeds is an RSS feed.

15. The system of claim 11, wherein the user-entered term is at least one of a pre-defined node, asset, category, and keyword.

16. The system of claim 15, wherein the pre-defined node is at least one of “recent”, “popular”, and “budget”.

17. The system of claim 15, wherein the asset is a collection of content available from the domain.

18. The system of claim 17, wherein the asset is at least one of “product”, “software”, “news”, “blogs”, and “discussions”.

19. The system of claim 15, wherein the category is a subset of the asset.

20. The system of claim 19, wherein the category is at least one of “computers”, “cameras”, “cell phones”, “games”, “printers”, “televisions”, and “MP3 players”.
